(19) United States
(12) Patent Application Publication
(10) Pub. No.: US 2004/0041140 A1
(43) Pub. Date: Mar. 4, 2004

(54) Cable barrier and method of mounting same

(76) Inventors: Roland Johansson, Holo (SE); Johnny Mattsson, Mariestad (SE)

Correspondence Address: JACOBSON HOLMAN PLLC, 400 SEVENTH STREET N.W., SUITE 600, WASHINGTON, DC, 20004, US

(21) Appl. No.: 10/399,860

(22) PCT Filed: Oct. 26, 2001
(86) PCT No.: PCT/SE01/02354

(30) Foreign Application Priority Data
Oct. 27, 2000 (SE) 0003917-2

(51) Int. Cl. A01K 3/00

(52) U.S. Cl. 256/13.1

(57) ABSTRACT

Preventing accidents and reducing the consequences thereof are matters that have become more and more important as the volume of traffic increases in society. One way of reducing the consequences of accidents is to mount safety barriers along the roads to prevent cars from leaving the road or getting into the opposite roadway. The invention relates to a safety barrier of the type steel cable barrier, also called wire barrier. Prior-art steel cable barriers require extensive and time-consuming work for mounting. A barrier has two wire anchoring foundations (4) and a plurality of wire post foundations (5) of concrete which are to be buried. Digging work that may cause subsidence that must be repaired later. The invention discloses a steel cable barrier (1) which solves these problems. A steel cable barrier (1) according to the invention comprising wires (2), wire posts (3) and a wire anchor (7) comprising a ground anchoring means (41) with anchoring wings (43) which are pressed or driven down into the ground. The invention also relates to a method of mounting a steel cable barrier (1) by a wire anchor (7) being pressed or driven down into the ground.

The present invention relates to a steel cable barrier for roads and a method of mounting a steel cable barrier.

Road safety matters are becoming more and more important as the volume of traffic increases in society. Preventing accidents and reducing the consequences thereof are matters in which more and more people are being involved. A manner of reducing the consequences is to mount safety barriers along the roads to prevent cars from leaving the road or getting into the opposite roadway. On today's motorways where the lanes are in most cases separated by a ditch only, or on arterial roads where there is nothing to separate the lanes, there is a risk that a car gets on the wrong side of the road with the ensuing serious injuries and vehicle damage.

Safety barriers have been in use for a long time. Above all barriers with horizontal beams have been used to prevent vehicles from slipping off the road in particularly exposed places, such as bridges and viaducts, or as a central barrier on motorways. Safety barriers of this type, however, suffer from a number of drawbacks. In addition to being expensive they are in the first place intended to prevent a vehicle from leaving the road and they are thus heavy and can affect vehicles and passengers to an unnecessarily great extent.

The wish to reduce injuries has resulted in steel cable barriers, also called wire barriers, being seen as a solution. The barrier functions in such manner that steel cables (wires) catch the lateral forces and cause the car to follow the safety barrier until it stops or until the driver himself can resume control of his car and make it slow down.

Steel cable barriers and methods of mounting the same are disclosed in, inter alia, U.S. Pat. No. 6,065,738 A and U.S. Pat. No. 5,039,066. The first US document discloses how a wile is fixed to a concrete foundation by means of a safety device that releases the wire if a car should be clamped between the wire and the road. The second document discloses posts with fixing means for the wire and concrete foundations for the posts.

A problem of prior-art steel cable barriers is that extensive work is necessary for mounting. Wire anchoring foundations and post foundations are made of concrete and, thus, large and heavy, which requires a great conveying and lifting capacity. Moreover, they must be buried in the ground, thus necessitating extensive digging work, causing traffic jam and putting road-workers in jeopardy for a long time.

Another problem that arises in digging adjacent to or in a road is that subsidence arises some time after the road has been repaired and provided with a new paving. This means that road-workers have to apply a new paving once more. Since great digging operations interfere with the road to a great extent, the damage owing to subsidence will also be great, requiring the use of a plurality of vehicles with road-workers for repair. Taken together, this causes traffic jam and costs a lot of money.

One more problem is that post foundations of concrete have been found to come loose from the ground in case of collision. Except that this involves extra work in burying new foundations and repairing the ground, the foundation may also cause severe damage when being pulled up from the ground.

The object of the present invention is to provide a steel cable barrier that solves the above problems. According to the invention this is achieved by a steel cable barrier, comprising wires, wire posts and a wire anchor, which has a ground anchoring means with anchoring wings which are pressed or driven down into the ground, and a method of mounting a steel cable barrier by a wire anchor being pressed or driven into the ground.

The invention will now be described in more detail with reference to the accompanying drawings.

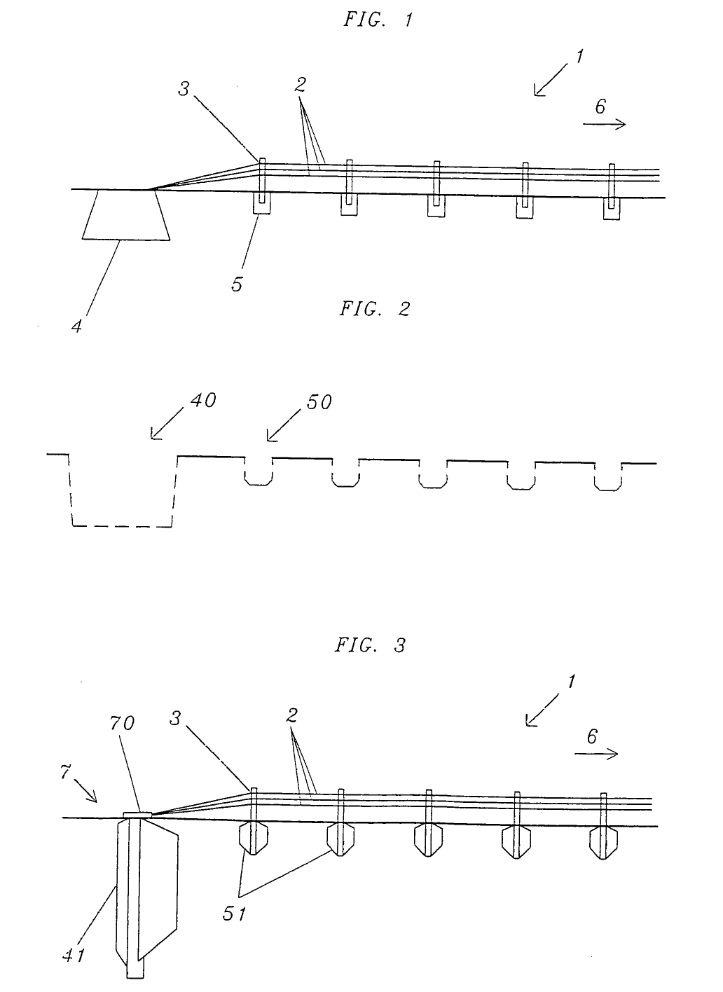

FIG. 1 shows a steel cable barrier according to prior art.

FIG. 2 shows ground work that is necessary with prior art.

FIG. 3 shows a steel cable barrier according to the invention.

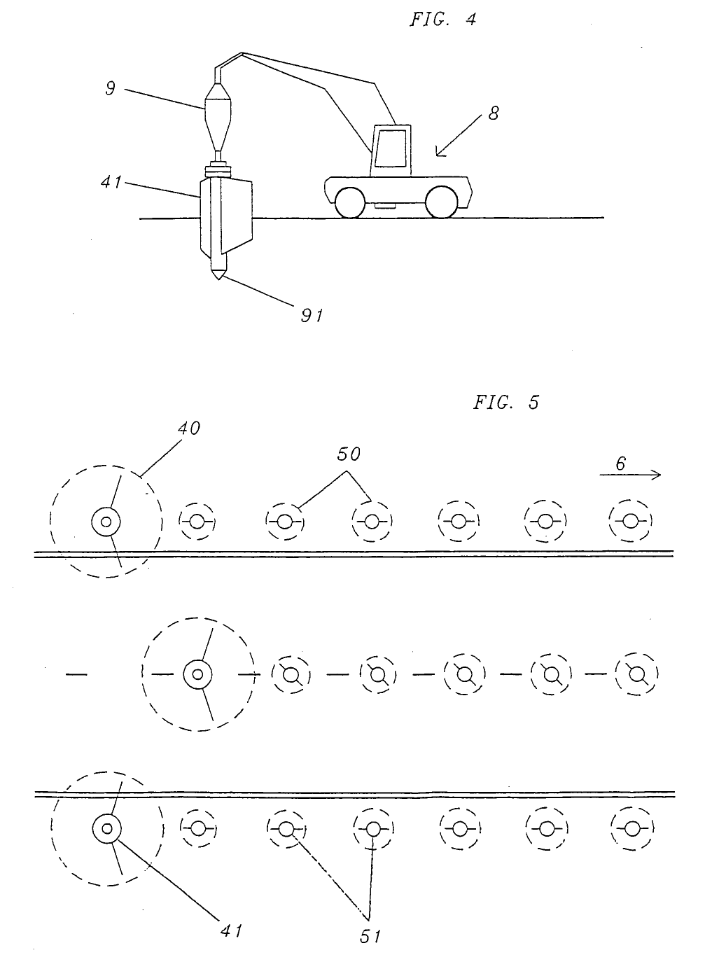

FIG. 4 shows ground work with the steel cable barrier according to the invention.

FIG. 5 is a top plan view of a road.

FIG. 6 illustrates a ground anchoring means according to the invention.

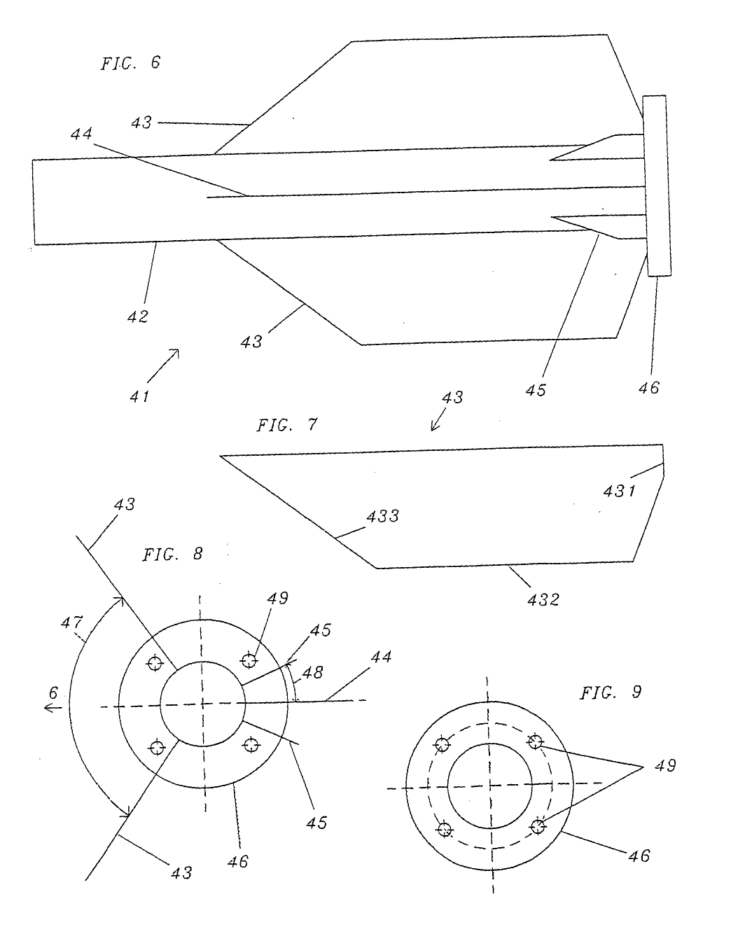

FIG. 7 illustrates a wing of a ground anchoring means.

FIG. 8 is a bottom view of the around anchoring means according to the invention.

FIG. 9 illustrates a top plate for the ground anchoring means.

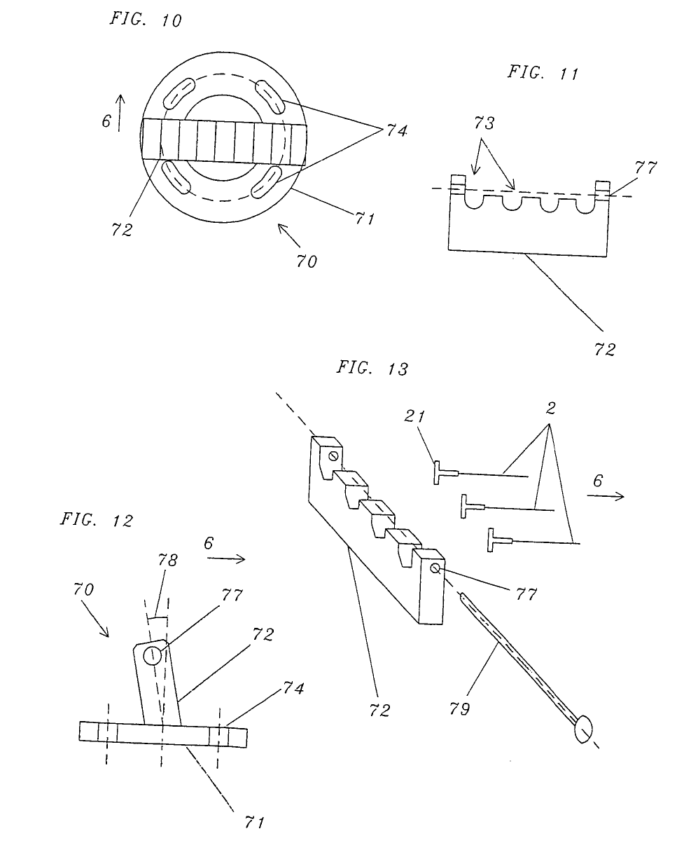

FIG. 10 is a top plan view of a wire anchoring means.

FIG. 11 shows a wire anchoring cam.

FIG. 12 is a side view of the wire anchoring means.

FIG. 13 shows a wire anchoring cam with a locking device

FIG. 1 shows a steel cable barrier (1) according to prior art. The barrier (1) has a number of wires (2) which are supported by wire posts (3). At each end of the barrier (1), the wire (2) is anchored in the around by means of a wire anchoring foundation (4). The foundation (4) is in most cases a prefabricated concrete block or a block cast in situ. The wire posts (3) are also anchored in the ground by means of post foundations (5) of concrete. A wire anchoring foundation (4) weighs between 2000 and 4000 kg and a post foundation (5) between 30 and 100 kg. FIG. 2 shows that the ground work that is necessary to bury the wire anchoring foundation (4) and the post foundation (5) is extensive and causes great damage to the ground and the road.

FIG. 3 shows a steel cable barrier (1) according to the invention. The barrier (1) has a number of steel wires (2) which are supported by wire posts (3). At each end of the barrier (1), the wire (2) is anchored in the ground, by ground here being meant also road, road embankment and other areas round a road, by means of a wire anchor (7). The wire anchor (7) is pressed or driven into the ground or road, which means that no digging work is necessary. FIG. 4 shows flow a working vehicle with a percussion hammer (9) drives a ground anchoring means (41) belonging to a wire anchor (7) into the ground. In order not to need to dig a hole for the wire post foundations (5), a post anchor (51) is used which is also driven into the ground. The post anchor can be of different types. FIG. 5 showing the traces of a ground anchor with two wings, but it is also possible to use an anchor with three wings (FIG. 3) or more. FIG. 5 also shows how the wings of the ground anchor can be arranged. Ground anchors (51) which are driven into the ground along the road have their wings parallel with the road, and ground anchors that are driven into the centre of the road have their wings rotated through 45 degrees to the direction of the road.

The wire post (3) carries the wire (2) and withstands vertical forces whereas application of a load in the horizontal direction, for instance a collision, results in the wire post (3) being folded without the anchor (5) being affected. This is achieved by the wire post (3) being made of a material of such a thickness as to make it yield in case of a collision, by arranging weakened portions at the root of the post or the like.

FIG. 5 shows the difference in damage to the ground and the road when mounting a steel cable barrier along a road and in the centre of a road. According to prior art, a plurality of large holes (40) for the wire anchoring foundations must be digged as must also a large number of small holes (50) for the foundations of the wire posts. Using wire anchoring and anchoring of wire posts according to the invention, only long narrow holes arise after the anchoring wings. Holes that are easy to mend and that do not cause any damage to underlying layers in the ground and the road that may give rise to future subsidence.

FIG. 6 shows an embodiment of a ground anchoring means (41) according to the invention. The ground anchoring means comprises a tube (42), two anchoring wings (43), a reinforcing wing (44), two supporting wings (45) and a top plate (46). An example of an anchoring wing is illustrated in FIG. 7. The anchoring wing (43) has an upper horizontal part (431) supporting the top plate (46), a pointed side (433) and a vertical side (432). Depending on the ground conditions, the properties and number of the anchoring wing may need to be changed in many different waifs, e.g. more pointed-more blunt, wider-narrower, longer-shorter or three-four wings. To support the top plate (46), use is made of two supporting wings (45) and the anchoring wings (43). The top plate (46) has a centre hole of the same size as the outer diameter of the tube (42) and encloses the outermost end of the tube (42). The top plate (46) is conveniently welded to the tube (42) and to the supporting and anchoring wings (43, 45).

FIG. 8 shows the ground anchoring means seen from below. The two anchoring wings (42) are symmetrically arranged and directed towards the wire direction (6) at an angle (47) of 110 degrees between them. Depending on the ground conditions etc, ground anchoring means (41) with the wings (43) placed at a different angle (47) may have to be used. However, the angle (47) should not be greater than 180 degrees. FIG. 8 also shows the two supporting wings (45) and the reinforcing wing (44) arranged away from the wire direction (6). The supporting wings (45) are symmetrically arranged at an angle (48) to the reinforcing wing (44). The angle (48) is 30 degrees but may be varied depending on the angle (47) of the anchoring wings so as to obtain a suitable support for the top plate (46). The reinforcing wing (44) is arranged along, the tube (42) to prevent the tube from being bent when exposed to strains. When a vehicle collides with the barrier (1), the wires (2) are subjected to great forces which are transferred down in the wire anchor (7). For the wire anchor to be able to take up the forces, it is important that the forces affect the ground anchoring means (41) in the correct direction. Ground anchoring means of this type are relatively poor at taking up vertical forces striving to pull out the anchor. The same applies if the ground anchoring means can be pulled up/made to climb up obliquely, for instance at the angle at which the wire extends to the wire anchor. This occurs if the tube (42) bends and must be prevented. A simple way of preventing this is to arrange one or more reinforcing wings (44) on the pipe (42) oil the side opposite to the side where the wires (2) are inserted.

FIG. 10 illustrates a wire anchoring means (70) comprising a plate (71) with elongate holes (74) and a cam part (72). The wire anchoring means (70) is mounted on the top plate (46) by means of an adjustable attachment, here shown as threaded holes (49) in the top plate (46) and elongate holes (74) in the plate (71). Bolts are passed down through the elongate holes (74) and fastened in the threaded holes (49). The elongate holes (74) make it possible to adjust the wire anchoring means so that the cam part (72) is perpendicular to the wire direction (6) even if the ground anchoring means (41) should have turned while being driven into the ground.

FIGS. 11 and 13 show the cam part (72) with recesses (73) and a locking device in the form of holes (77) and a bolt (79). The wires (2) have at their ends an end fitting (21) which fits into the recesses (73) on the cam part (72). When the end fittings have been arranged in the cam part (72), they are locked by the bolt being passed through the holes (77). In order to further tighten the wires (2), turnbuckles are arranged on the wires.

FIG. 12 shows how the cam part (72) is arranged on the plate (74). The cam part (72) is inclined from the wire direction (6) at an angle (78) that depends on how the wires (2) come down. Suitably the wires should extend at an angle of about 90 degrees to the cam part. According to the invention, an angle (78) of 5-20 degrees, and most advantageously about 8 degrees, is preferred, which results in a distance between the wire anchor and the first wire post as well as load take-up that follow current standards.

There is a risk that the wire anchor (7) is subjected to external effects that may damage the wire attachment and if it comes to the worst, loose the wires (2) and make the entire steel cable barrier (1) ineffective. The external effects can be, for instance, in the form of a road grader or a snowplough. To prevent this, a safety cover can be arranged on the wire anchoring means (7) which lets the snowplough pass over it, or a safety cover can be arranged round the wire anchor (7) to prevent the plough from coming close.

1. A steel cable barrier (1) for roads, comprising one or more wires (2) one or more wire posts (3), and one or more wire anchors in the ground, characterised in that the wire anchor (7) comprises a ground anchoring means (41) with anchoring wins (43) which are pressed or driven down into the ground.

2. A steel cable barrier (1) as claimed in claim 1, characterised in that at least one of the wire posts (3) is anchored using a ground anchoring means (51) with wings.

3. A steel cable barrier (1) as claimed in claim 1 or 2, characterised in that the wire posts (3) are made with a thickness which is yieldable when being hit.

4. A steel cable barrier (1) as claimed in any one of claims 1-3, characterised in that the wire anchor (7) comprises a wire anchoring means (70) mounted on the ground anchoring means (41).

5. A steel cable barrier (1) as claimed in any one of claims 1-4, characterised in that the ground anchoring means (41) comprises a tube (42) with two anchoring wings (43) symmetrically arranged towards the wire direction (6) at an angle (47) of less than 180 degrees between them.

6. A steel cable barrier (1) as claimed in claim 5, characterised in that the angle (47) is 80-140 degrees.

7. A steel cable barrier (1) as claimed in claim 6, characterised in that the angle (47) is 110 degrees.

8. A steel cable barrier (1) as claimed in an one of claims 5-7, characterised in that a reinforcing wings (44) is arranged along the major part of the length of the tube (42), parallel with the wire direction (6) but on the opposite side of the tube (42).

9. A steel cable barrier (1) as claimed in any one of claims 1-8 characterised in that the ground anchoring means (41) comprises a top plate (46) arranged round the tube (42) and having an attachment (49) for a wire anchoring means (70).

10. A steel cable barrier (1) as claimed in claim 9, characterised in that the wire anchoring means (70) comprises a plate (71), a fixing cam (72), with recesses (73) for one or more end fittings (21), and a locking device (79) which prevents the end fitting/fittings (21) from leaving the recess/recesses (73).

11. A steel cable barrier (1) as claimed in claim 10, characterised in that the fixing cam (72) is arranged upright from the plate (71) at an angle (78) of 5-20 degrees from the vertical, inclined from the wire direction (6).

12. A steel cable barrier (1) as claimed in claim 11, characterised in that the angle (78) is 5-10 degrees, preferably 8 degrees.

13. A steel cable barrier (1) as claimed in any one of claims 9-12, characterised in that the wire anchoring means (70) has a safety cover protecting it from being hit by a snowplough, road grader or the like.

14. A steel cable barrier (1) as claimed in claim 13, characterised in that the safety cover is arranged on the wire anchoring means (70) or that the safety cover is arranged round the wire anchor (7).

15. A method of mounting a steel cable barrier (1) along a road, comprising at least one wire (2), at least one wile post (3) and at least one wire anchor, characterised in that
the wire anchor (7) is pressed or driven down into the ground/road;
the wire (2) is anchored in the wire anchor (7).

16. A method as claimed in claim 15, characterised in that
the wire anchor (7) comprises a ground anchoring means (41) and a wire anchoring means (70);
the ground anchoring means (41) is driven down into the ground/road;
the wire anchoring means (70) is then mounted on the ground anchoring means (41);
the wire (2) is mounted in the wire anchoring means (70).

17. A method as claimed in claim 16, characterised in that
the wire anchoring, means (70) is adjustably mountable on the ground anchoring means (41);
the wire anchoring means (70) locks the wire (2) by means of a locking device (21, 77, 79).

18. A method as claimed in claim 6 or 7 characterised in that
the ground anchoring means (71) is driven down into the ground using a percussion hammer (9);
the ground anchoring means (41) comprises a tube (42) in which a point (91) of the percussion hammer (9) is passed through;
the point (91) presses away earth to give place for the tube (42).

19. A method as claimed in any one of claims 15-18, characterised in that
a wire post (3) is anchored with a ground foundation (51) provided with wings;
the ground foundation (51) is pressed or driven down into the ground/road.
